(19) United States
(12) Patent Application Publication
(10) Pub. No.: US 2007/0289690 A1
(43) Pub. Date: Dec. 20, 2007

(54) Method for manufacturing a ceramic stack

(75) Inventors: Eturo Yasuda, Okazaki-shi (JP); Noriaki Kihara, Okazaki-shi (JP); Hirokatsu Mukai, Kuwana-shi (JP); Daisuke Makino, Ichinomiya-shi (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 11/808,977

(22) Filed: Jun. 14, 2007

(30) Foreign Application Priority Data
Jun. 14, 2006 (JP) 2006-164238

(51) Int. Cl. C03B 29/00

(52) U.S. Cl. 156/89.11

(57) ABSTRACT

A method for manufacturing a ceramic stack is provided, which can suppress distortion, separation, cracking and the like that may be caused in plural types of ceramic sheets after being stacked and baked for integration. The method includes a step of obtaining a relation between volume rates of organic materials contained in the ceramic sheets and baking shrinkages of the sheets, resulting from baking the sheets at a predetermined temperature, a step of selecting a volume rate of organic materials for each of the ceramic sheets based on the relation obtained at the previous step, so that all the sheets may have substantially the same baking shrinkage as desired, a step of forming the plural types of ceramic sheets based on the volume rate selected at the previous step, and a step of stacking and baking for integration the plural types of ceramic sheets to fabricate a ceramic stack.

### CROSS-REFERENCE TO RELATED APPLICATION

This application is based on and claims the benefit of priority from earlier Japanese Patent Application No. 2006-164238 filed Jun. 14, 2006, the description of which is incorporated herein by reference.

### BACKGROUND OF THE INVENTION

1. Technical Field of the Invention

The present invention relates to a method for manufacturing a ceramic stack used for a gas sensing element, for example, which is formed by stacking plural types of ceramic sheets, followed by baking for integration.

2. Related Art

As disclosed in Japanese Patent Laid-Open Publication No. 2002-181764, an air-furl ratio sensor or a nitrogen oxide (NOx) sensor, for example, has been developed as a gas sensor used for measuring gas components in an exhaust gas of an internal combustion engine such as of a vehicle. A gas sensing element incorporated in such a gas sensor is generally made up of a stack of plural ceramic layers each of which has different ceramic components and have different porosity levels required.

A ceramic stack structuring a gas sensing element is fabricated, for example, by stacking ceramic sheets structuring respective layers and thermally compressing or bonding the stack with an adhesive, followed by baking for integration, as disclosed in Japanese Patent Laid-Open Publication No. 2002-340843.

However, difference in baking shrinkage between the individual ceramic sheets in the above method may create a problem that distortion or separation may be caused in the ceramic sheets after being baked. This may lead to deterioration in the dimensional accuracy or qualities of the ceramic stack.

In order to mitigate the distortion or separation of the ceramic sheets resulting from baking, a method has been provided in which baking is performed by putting a weight on the stacked ceramic sheets. However, this method of forcibly mitigating the distortion or separation by putting weight may cause the ceramic sheets to suffer residual stress, which may induce cracking in the ceramic sheets.

Japanese Patent Laid-Open Publication No. 2002-286680 suggests use of the same types of ceramic components for structuring individual layers of a gas sensing element to achieve substantially the same baking shrinkage and sintering behaviors in the individual layers, thereby suppressing distortion or separation resulting from baking. This method, however, cannot be used where the ceramic components or required porosities are different between the individual layers.

Under such circumstances, there has been a demand for a method for manufacturing a ceramic stack, which can suppress such defects as distortion and separation of plural types of ceramic sheets having, for example, different ceramic components and different porosities as required after baking, and structuring the ceramic stack.

### SUMMARY OF THE INVENTION

The present invention has been made in light of the problem described above and has an object of providing a method for manufacturing a ceramic stack, which can suppress distortion, separation or cracking, for example, which may be caused by stacking and baking for integration plural types of ceramic sheets.

To achieve the above object, as one mode, the present invention provides a method of manufacturing an integrated ceramic stack containing a plurality of types of ceramic sheets. This manufacturing method comprises an obtaining step, a selecting step, a sheet forming step, and a baking step. Of these, in the obtaining step, a relationship between a rate of volume of an organic matter being contained in each of the ceramic sheets and a shrinkage of each of the ceramic sheets during a baking process thereof is obtained, the relationship being based on a case where each of the ceramic sheets is prepared as a sheet material in which a ceramic material is mixed with the organic matter of a predetermined amount, the sheet material is formed, and then formed sheet material is baked at a predetermined temperature. Then in the selecting step, the rate of the volume of the organic matter being contained in each of the ceramic sheets is selected using the obtained relationship so that all the ceramic sheets have desired shrinkages falling into a predetermined range of shrinkages when the plurality of types of ceramic sheets are baked. In the sheet forming step, each of the sheet materials is prepared by mixing the organic matter with the ceramic material based on the selected rate of the volume of the organic matter and the prepared sheet materials are formed into the plurality of types of ceramic sheets. And, in the baking step, the plurality of types of ceramic sheets are stacked on one another and the stacked ceramic sheets are baked to produce the integrated ceramic stack.

The ceramic stack manufactured in the present invention is obtained by stacking a plurality of ceramic sheets having different ceramic components and different porosity required after baking, for example, and by baking them for integration. In stacking and integrally baking such plural types of ceramic sheets, distortion or separation caused by baking should be suppressed, and residual stress should be reduced so as not to cause cracking inside. To this end, it is important to match, as much as possible, the baking shrinkage between the respective ceramic sheets.

The ceramic sheets before baking are each obtained by mixing organic materials, such as binders, dispersants and plasticizers, into a ceramic material, and by forming the sheet materials into respective sheets. Each of these ceramic sheets is thus primarily made of inorganic materials (ceramic materials) and organic materials (e.g., binder, dispersant and plasticizer). Baking of such ceramic sheets may cause the organic materials to burn to leave voids, and on the other hand may cause the inorganic materials to be reconstructed as the temperature rises so as to reduce the voids left by the burning of the organic materials. Finally, the ceramic sheets may shrink in proportion to the number of the voids.

Thus, the baking shrinkage of the ceramic sheets is associated with the volume of the organic materials which are contained in the respective ceramic sheets before baking and are burnt during baking, leaving voids.

In order to control the baking shrinkage of the ceramic sheets, the present invention adjusts the rate of volume of organic materials contained in each ceramic sheet (when necessary, referred to as an “organic-volume rate”) before baking. Specifically, the organic-volume rate of the ceramic sheets before baking is adjusted in consideration of permitting the individual ceramic sheets to have substantially the same baking shrinkage as desired to suppress distortion, separation, cracking and the like of the individual ceramic sheets, which may otherwise have resulted from baking.

More specifically, at the step of measuring shrinkage, a relation is obtained between an organic-volume rate before baking and a baking shrinkage of each of the after-baking ceramic sheets. In particular, variation in the baking shrinkage depending on the organic-volume rate of each ceramic sheet is investigated. At the step of selecting organic-volume rate, the organic-volume rate of each of the ceramic sheets is selected in advance based on the relation between the organic-volume rate and the baking shrinkage obtained at the previous step, so that all of the ceramic sheets may substantially have the same baking shrinkage as desired.

Then, at the step of forming sheets, plural types of ceramic sheets are fabricated based on the respective organic-volume rates previously selected. The fabricated plural types of ceramic sheets are then stacked and baked for integration at the baking step to fabricate a ceramic stack.

As described above, the ceramic sheets fabricated at the step of forming sheets are ensured to have substantially the same shrinkage when baked. In this way, all of the plural types of ceramic sheets, after being baked and stacked for integration at the baking step, may have substantially the same baking shrinkage to suppress distortion, separation, cracking and the like of the ceramic sheets, which may otherwise have resulted from baking. In addition, the ceramic stack to be obtained may have high dimensional accuracy and high qualities.

It is preferable that the plurality of types of ceramic sheets includes a porosity adjusting sheet of which ceramic material is given as a ceramic adjusting material composed of a mixture of two types of adjustment materials for adjusting the porosity, the two types of adjustment materials being different in particle diameter and/or tap density from each other, the method further comprising: a further obtaining step in which a relationship between a mixture ratio of the two types of adjustment materials in the ceramic adjusting material and the porosity of the porosity adjusting sheet is obtained, the relationship between the mixture ratio and the porosity being based on a case where the porosity adjusting sheet in which the organic matter is mixed with the ceramic adjusting material at a selected volume rate is baked; a further selecting step in which the mixture ratio of the adjustment materials is selected using the obtained relationship between the mixture ratio and the porosity so that the porosity adjusting sheet has a desired porosity after the baking; and a producing step in which the two types of adjustment materials are mixed with each other based on the selected mixture ratio so as to produce the ceramic adjusting material, the producing step for producing the ceramic adjusting material being followed by the obtaining step for obtaining the relationship between the volume rate and the shrinkage, wherein the selecting step for selecting the volume rate is configured to select the volume ratio of the organic matter being contained in each of the ceramic sheets using the obtained relationship between the volume ratio and the shrinkage so that all the ceramic sheets have shrinkages falling into a predetermined range into which the shrinkage of the porosity adjusting sheet falls, when the plurality of types of ceramic sheets are baked.

Specifically, in order to control the after-baking porosity of the particular ceramic sheet to be adjusted porosity mentioned above (when necessary, referred to as a “porosity-adjustment sheet”), the present invention uses various adjusted ceramic materials, which are obtained by mixing two types of adjustment materials having different particle sizes or/and different tap densities, into a ceramic material at different ratios to select an appropriate mixing ratio of these two types of adjustment materials.

More specifically, the step of measuring after-baking porosity and the step of selecting mixture ratio are performed to select, in advance, the mixture ratio of the adjustment materials to be contained in the adjusted ceramic material which is to be used for the porosity-adjustment sheet, so that the porosity-adjustment sheet may have a desired after-baking porosity. At the subsequent step, the adjusted ceramic material is prepared based on the selected mixture ratio so as to be used as a ceramic material for the porosity-adjustment sheet.

Thus, the porosity-adjustment sheet may have a desired porosity after performing the baking step. With reference to the porosity-adjustment sheet, all of the ceramic sheets can be ensured to have substantially the same baking shrinkage.

It should be appreciated that, at the step of selecting organic-volume rate, the organic-volume rate for each of the ceramic sheets is selected using the porosity-adjustment sheet as a reference sheet which has been prepared so as to have the optionally selected organic-volume rate by using the adjusted ceramic material obtained at the step of making adjusted ceramic material. The reason for using the porosity-adjustment sheet as a reference sheet is that the after-baking porosity of the porosity-adjustment sheet has previously been adjusted, and that the baking shrinkage of the respective sheets is adjusted to that of the porosity-adjustment sheet.

It is preferable that the plurality of types of ceramic sheets includes a profile adjusting sheet for adjusting a profile indicating behaviors of the shrinkage when being baked and being expressed by a relationship between a baking temperature and the shrinkage, the profile adjusting sheet using a disintegrated ceramic material produced by disintegrating granulated ceramic powders for a predetermined period of time, the granulated ceramic powders being formed by granulating the ceramic material, the method further comprising: a further obtaining step, which follows the selecting step for selecting the volume rate of the organic matter, in which, when the profile adjusting sheet is backed, the profile is obtained every disintegration time during which the granulated ceramic powers are subjected to the disintegration; a further selecting step in which, based on a relationship between the obtained profile and the disintegration time, a disintegration time for the granulated ceramic powders is selected such that the profile of the profile adjusting sheet best approaches a profile of the shrinkage of a ceramic sheet selected other than the profile adjusting sheet; and a producing step in which, based on the selected disintegration time, the granulated ceramic powders are disintegrated to produce the disintegrated ceramic material, wherein the sheet forming step, which follows the producing step for producing disintegrated ceramic material, is configured to form the ceramic sheets such that the profile adjusting sheet uses, as the ceramic material therefor, the disinterested ceramic material produced in the producing step for producing the disintegrated ceramic material.

Specifically, in order to control the profile of baking shrinkage (when necessary, referred to as “baking-shrinkage profile”) of the particular ceramic sheets to be adjusted profile mentioned above (when necessary, referred to as “profile-adjustment sheet(s)”), the present invention uses disintegrated ceramic materials obtained by disintegrating granulated ceramic powders. The time period of disintegrating the individual granulated ceramic materials is adjusted.

More specifically, the step of measuring profile for every disintegration time period and the step of selecting disintegration time period are performed to select, in advance, a disintegration time period for each of the granulated ceramic powders, so that the baking-shrinkage profile of each profile-adjustment sheet may maximally approximate the baking-shrinkage profile of the optionally selected ceramic sheet (which corresponds to the porosity-adjustment sheet described above). At the step of making disintegrated ceramic material, adjusted ceramic materials are prepared based on the selected disintegration time periods, for use as the ceramic materials for the respective profile-adjustment sheets.

Granulation of each of the ceramic materials can produce the granulated ceramic powder, which is made up of agglomerated powder in which fine particles of ceramic material having small particle size are agglomerated. The agglomerated powder is then disintegrated, and the degree of disintegration may adjust the baking shrinkage of each of the profile-adjustment sheets. In particular, the degree of disintegration can give effects when the sheets are baked at low temperature (around 1,200 C) and may vary the baking shrinkage.

Thus, the baking-shrinkage profiles of all the ceramic sheets including the profile-adjustment sheet can be more approximated. At the same time, the baking shrinkage of all the ceramic sheets can be ensured to be substantially the same. In this way, distortion, separation, cracking and the like that may result from baking can be further suppressed. Also, the ceramic stack to be obtained may have higher dimensional accuracy and higher qualities.

It should be appreciated that the disintegration of each granulated ceramic powder can be carried out by using a ball mill, for example. In this case, only a solvent may be mixed into the granulated ceramic powder, or organic materials, such as a binder, may be additionally mixed.

It is preferable that the plurality of types of ceramic sheets includes a profile adjusting sheet for adjusting a profile indicating behaviors of the shrinkage when being baked and being expressed by a relationship between a baking temperature and the shrinkage, the profile adjusting sheet using a disintegrated ceramic material produced by disintegrating granulated ceramic powders for a predetermined period of time, the granulated ceramic powders being formed by granulating the ceramic material, the method further comprising: a further obtaining step, which follows the selecting step for selecting the volume rate of the organic matter, in which, when the profile adjusting sheet is backed, the profile is obtained every disintegration time during which the granulated ceramic powers are subjected to the disintegration; a further selecting step in which, based on a relationship between the obtained profile and the disintegration time, a disintegration time for the granulated ceramic powders is selected such that the profile of the profile adjusting sheet best approaches a profile of the shrinkage of the porosity adjusting sheet; and a producing step in which, based on the selected disintegration time, the granulated ceramic powders are disintegrated to produce the disintegrated ceramic material, wherein the sheet forming step, which follows the producing step for producing disintegrated ceramic material, is configured to form the ceramic sheets such that the profile adjusting sheet uses, as the ceramic material therefor, the disinterested ceramic material produced in the producing step for producing the disintegrated ceramic material.

Specifically, similar to the manner described above, in order to control the baking-shrinkage profile of the profile-adjustment sheets, the present invention uses disintegrated ceramic materials obtained by disintegrating granulated ceramic powders. The time period of disintegrating the individual granulated ceramic materials is adjusted.

More specifically, the step of measuring profile for every disintegration time period and the step of selecting disintegration time period are performed to select, in advance, a disintegration time period for each of the granulated ceramic powders, so that the profile of the baking shrinkage of each profile-adjustment sheet may maximally approximate the baking-shrinkage profile of the porosity-adjustment sheet. At the step of making disintegrated ceramic material, adjusted ceramic materials are prepared based on the selected disintegration time periods, for use as the ceramic materials for the respective profile-adjustment sheets.

Thus, the baking-shrinkage profiles of all the ceramic sheets including the profile-adjustment sheet can be more approximated. At the same time, the baking shrinkage of all the ceramic sheets can be ensured to be substantially the same. In this way, distortion, separation, cracking and the like that may result from baking can be further suppressed. Also, the ceramic stack to be obtained may have higher dimensional accuracy and higher qualities.

It should be appreciated that, at the step of selecting disintegration time period, the baking-shrinkage profile of the porosity-adjustment sheet is used as a reference profile to select the disintegration time periods of the granulated ceramic powders for the respective profile-adjustment sheets. The reason for using the baking-shrinkage profile of the porosity-adjustment sheet as a reference profile is that the after-baking porosity of the porosity-adjustment sheet has previously been adjusted, and that the baking shrinkage of the respective sheets is adjusted to that of the porosity-adjustment sheet.

Preferably, the granulated ceramic powders are produced by granulating the ceramic material based on a spray-drying technique.

Use of the spray-drying technique may facilitate granulation of each of the ceramic materials and may enable adjustment of the agglomeration degree of the ceramic material in the granulated ceramic powder. Thus, accuracy can be achieved in the adjustment of the baking-shrinkage profile of the ceramic sheet.

It should be appreciated that any method can be used for making the granulated ceramic powders if only the method can control the agglomeration degree of the ceramic materials.

Preferably, the sheet forming step is configured to produce the ceramic sheets by forming the seat materials based on a doctor-blade technique.

Use of the doctor-blade technique may reduce defects, such as voids, in the after-baking ceramic sheets, which can be led to the enhancement in the strength of the after-baking ceramic sheets, and further, to the improvement in the durability of the ceramic stack to be obtained.

It is preferable that the shrinkages of the plurality of type of ceramic sheets subjected to the baking step have a maximum shrinkage and a minimum shrinkage, a difference between the maximum and minimum shrinkages being within 1%.

This may allow sufficient suppression of distortion, separation, cracking and the like of the ceramic sheets that may result from baking. Thus, the ceramic stack to be obtained may have higher dimensional accuracy and higher qualities.

Preferably, the ceramic stack is used as an element for sensing a gas.

Use of the ceramic stack as a gas sensing element may more prominently allow exertion of the excellent characteristics of the ceramic stack, i.e. high dimensional accuracy and high qualities, as mentioned above. In particular, in light of the fact that the downsizing has increasingly advanced in gas sensors lately, and that the gas sensors have come to be used under higher-temperature circumstances, the gas sensors are now required to have higher dimensional accuracy and durability. The application of the high-quality ceramic stack to a gas sensing element may realize downsizing of the gas sensor, and at the same time, may provide a gas sensor having excellent durability.

### BRIEF DESCRIPTION OF THE DRAWINGS

In the accompanying drawings:

FIG. 1 is an illustration explaining the processes for fabricating a ceramic stack according to an embodiment of the present invention;

FIG. 2 is a graphic diagram illustrating a mixing ratio of alumina powders “a” and “b” in an alumina mixed powder relative to the porosity of a diffusion sheet, according to an embodiment of the present invention;

FIG. 3 is a graphic diagram illustrating an organic-volume rate in each ceramic sheet relative to baking shrinkage, according to an embodiment of the present invention;

FIG. 4 is a graphic diagram illustrating a profile of the baking shrinkage of a sensor sheet, according to an embodiment of the present invention;

FIG. 5 is a graphic diagram illustrating a profile of the baking shrinkage of a duct sheet, according to an embodiment of the present invention;

FIG. 6 is a graphic diagram illustrating profiles of the baking shrinkage of individual ceramic sheets, according to an embodiment of the present invention;

FIG. 7 is a development diagram illustrating a structure of a gas sensing element, according to an embodiment of the present invention;

FIG. 8 is an schematic diagram illustrating a structure of a gas sensing element, according to an embodiment of the present invention; and

FIGS. 9A to 9D are illustrations each explaining steps of fabricating a ceramic stack, according to an embodiment of the present invention.

### DETAILED DESCRIPTION OF THE PREFERRED EMBODIMENTS

With reference to the accompanying drawings, a method for manufacturing a ceramic stack according to an embodiment of the present invention will now be described.

The present embodiment is an example where the method for manufacturing a ceramic stack has been applied to a method for manufacturing a gas sensing element which is incorporated into an air-fuel ratio sensor used for controlling air-fuel ratio of an engine of a vehicle, for example.

A brief explanation is provided first on a gas sensing element (ceramic stack) 1 fabricated in the present embodiment.

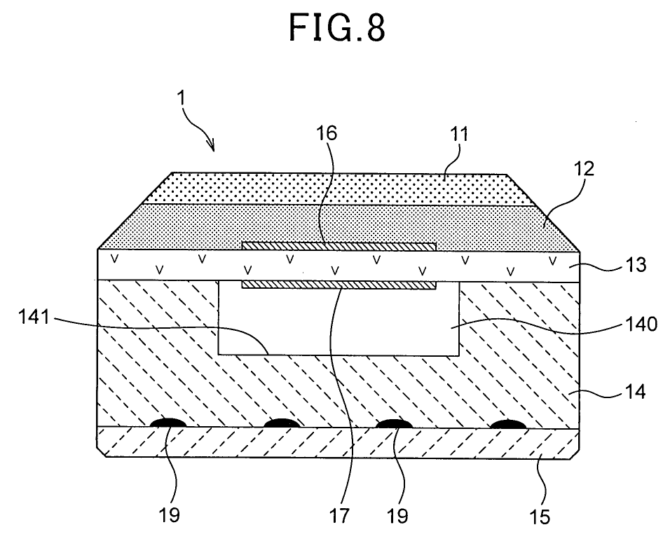

As shown in FIG. 8, the gas sensing element 1 is structured by stacking a plurality of ceramic layers in the order of a shield layer 11, a diffusion layer 12, a sensor layer 13, a duct layer 14 and a heater layer 15.

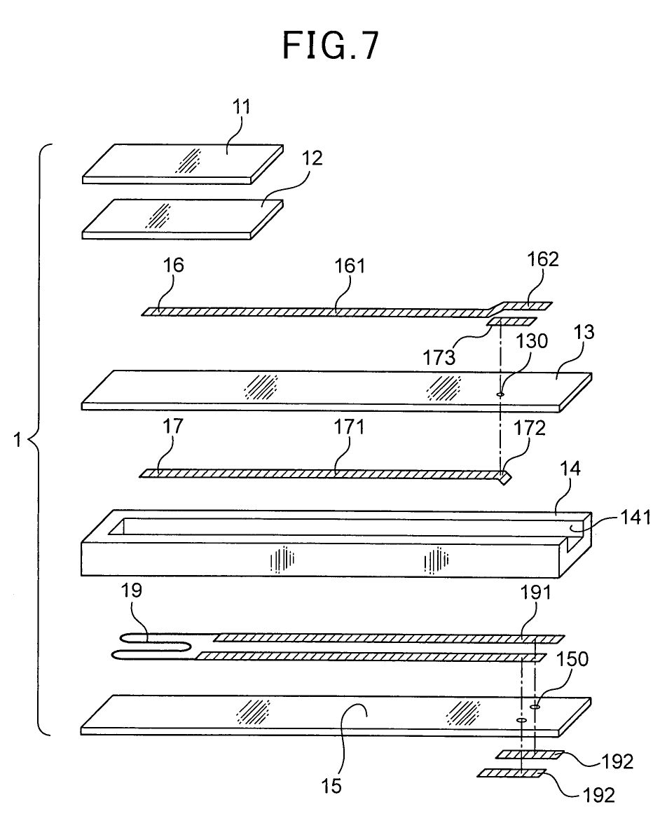

As shown in FIGS. 7 and 8, the sensor layer 13 is provided, on its surface facing the diffusion layer 12, with an electrode 16 on the side of a gas to be measured, a lead portion 161 connected to the electrode 16 and a terminal portion 162. The sensor layer 13 is also provided, on its surface facing the duct layer 14, with an electrode 17 on the side of a reference gas, a lead portion 171 connected to the electrode 17 and a terminal portion 172. The terminal portion 172 is electrically conductive with a terminal portion 173 through a conductor filled in a through hole 130, the terminal portion 173 being provided on the surface facing the diffusion layer 12.

Also, as shown in FIGS. 7 and 8, a groove portion 141 is formed in the duct layer 14 so as to function as a reference gas chamber 140. The reference gas chamber 140 is configured to introduce external air, for example, as a reference gas.

The heater layer 15 is provided, on its surface facing the duct layer 14, with a heater element 19 that generates heat with a supply of electric power, and a lead portion 191 for supplying electric power to the heater element 19. Further, a terminal portion 192 is provided to a surface, which is a rear face of the surface provided with the heater element 19 and the lead portion 191. The terminal portion 192 and the lead portion 191 are electrically conductive with each other through a conductor filled in a through hole 150.

The diffusion layer 12 has permeability to gases and is made of alumina ceramic having a porosity of 14.6±0.6%.

The sensor layer 13 is a solid electrolyte having oxygen ion conductivity and is made of dense zirconia ceramic having a porosity of 2% or less.

The duct layer 14 is made of dense alumina ceramic having a porosity of 2% or less.

The shield layer 11 and the heater layer 15 a substantially made of the same material as the duct layer 14.

Hereinafter is described a method for manufacturing the gas sensing element (ceramic stack) 1.

In fabricating the gas sensing element 1, sheet materials are provided first by mixing organic materials, such as binders, dispersants and plasticizers, into a ceramic material. The sheet materials are then each formed into the ceramic sheets 11 to 15 structuring the respective layers. Specifically, the present embodiment provides the shield sheet 11 that serves as a shield layer, the diffusion sheet 12 that serves as a diffusion layer, the sensor sheet 13 that serves as a sensor layer and the duct sheet 14 that serves as a duct layer.

These plural types of ceramic sheets 11 to 15 having different ceramic components and different porosities as required after baking are stacked and baked for integration to fabricate the gas sensing element 1.

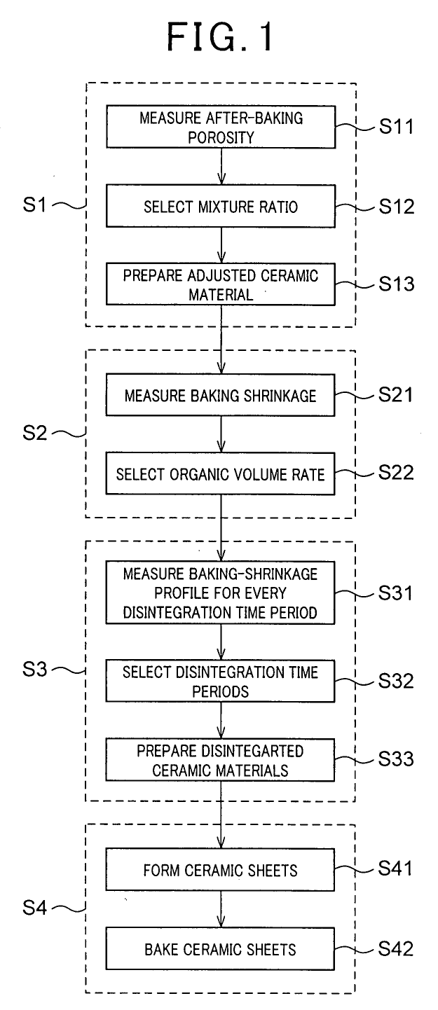

In particular, as shown in FIG. 1, at least a sub-step S21 of measuring shrinkage, a sub-step S22 of selecting organic-volume rate, a sub-step S41 of forming sheets and a sub-step S42 of baking are carried out.

At sub-step S21, a relation is obtained between the organic-volume rates of the ceramic sheets 11 to 15 before baking and the baking shrinkages of the ceramic sheets 11 to 15 resulting from being baked at a predetermined temperature in the baking step.

At sub-step S22, the organic-volume rates of the ceramic sheets 11 to 15 are selected so that all the ceramic sheets 11 to 15 may have substantially the same baking shrinkage as desired, based on the relation between the organic-volume rates and the baking shrinkages, which has been obtained at sub-step S21.

At sub-step S41, the organic materials are mixed into a ceramic material on the basis of the organic-volume rates selected at sub-step S22 to provide sheet materials for the respective ceramic sheets 11 to 15. The sheet materials are then each formed into the ceramic sheets 11 to 15.

At sub-step S42, the ceramic sheets 11 to 15 are stacked and baked for integration to fabricate the ceramic stack 1.

More details are provided below.

Among the ceramic sheets 11 to 15 to be fabricated, the diffusion sheet 12, or a diffusion layer, is ensured to have an after-baking porosity that falls within the range of 14.6 0.6%.

To this end, as shown in FIG. 1, a step S1 is performed to adjust the after-baking porosity of the diffusion sheet 12. Step S1 includes a sub-step S11 of measuring porosity, a sub-step S12 of selecting a mixture ratio and sub-step S13 of making an adjusted ceramic material, and these sub-steps are performed in this order. Thus, the ceramic material for the diffusion sheet 12 is adjusted in advance in consideration of controlling the after-baking porosity of the diffusion sheet 12 to be the one having a desired value.

<Sub-Step S11 of Measuring Porosity>

A ceramic material is prepared for the diffusion sheet 12 whose after-baking porosity is to be adjusted.

At this sub-step, an alumina mixed powder (adjusted ceramic material) is used as the ceramic material for the diffusion sheet 12. The alumina mixed powder is obtained by mixing two types of alumina powders “a” and “b” (adjustment materials) having different particle sizes and tap densities. In the present embodiment, the alumina powder “a” has a mean particle diameter of 0.3 m and a tap density of 1.40 g/cc, and the alumina powder “b” has a mean particle diameter of 0.4 m and a tap density of 0.81 g/cc.

The present embodiment makes use of the two adjustment materials which are different both in the mean particle diameter and the tap density. However, the two adjustment materials may be different only in the mean particle diameter or in the tap density.

Then, various diffusion sheets 12 having organic materials by a volume rate of 50% are fabricated using the alumina mixed powders having different mixture ratios of alumina powders “a” and “b”. Then, porosities of these diffusion sheets 12 obtained after being baked in the baking step are measured. It should be appreciated that the organic-volume rates of the diffusion sheets 12 are optionally selected.

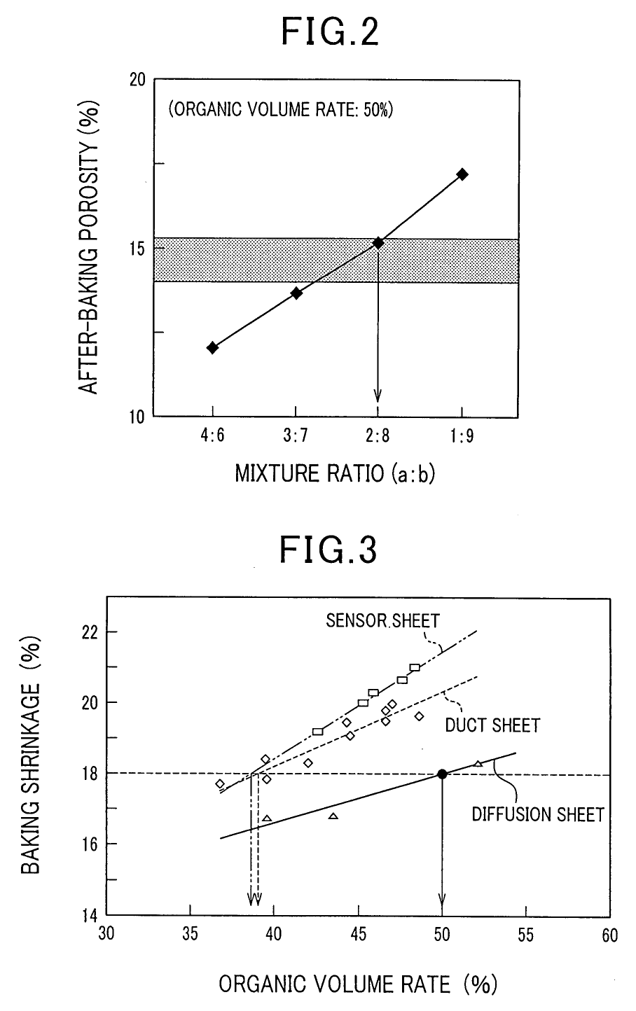

Thus, as shown in FIG. 2, a relation is obtained between the mixture ratio of the alumina powders “a” and “b” and the after-baking porosity.

<Sub-Step S12 of Selecting Mixture Ratio>

Subsequently, based on the relation between the mixture ratio and the after-baking porosity (see FIG. 2) obtained at sub-step S11, the mixture ratio of the alumina powders “a” and “b” is selected so that the after-baking porosity of the diffusion sheet 12 may fall within the range of 14.6 0.6%.

As can be seen from FIG. 2, the mixture ratio of 2:8 assures the after-baking porosity to fall within the above range. Thus, in the present embodiment, the mixture ratio of the alumina powders “a” and “b” is selected as being 2:8.

<Sub-Step S13 of Making Adjusted Ceramic Material>

Subsequently, based on the mixture ratio selected at step S12, the alumina powders “a” and “b” are mixed at the ratio of 2:8 to make an alumina mixed powder M12 (adjusted ceramic material).

It should be appreciated that, at a later step, this alumina mixed powder M12 made at this sub-step is used as the ceramic material for the diffusion sheet 12.

Then, as shown in FIG. 1, a step S2 is performed to adjust the baking shrinkage of the ceramic sheets 11 to 15. Step S2 includes the sub-step S21 of measuring baking shrinkage and the sub-step S22 of selecting an organic-volume rate, and these sub-steps are performed in this order. Thus, subsequent to the adjustment of the after-baking porosity of the diffusion sheet 12, the organic-volume rate for each of the ceramic sheets 11 to 15 is selected, in advance, in consideration of matching the baking shrinkage between the ceramic sheets 11 to 15.

It should be appreciated that the shield sheet 11 and the heater sheet 15 are made of substantially the same ceramic material as the duct sheet 14. Step S2 of the present embodiment therefore is performed to match the baking shrinkage of the diffusion sheet 12, the sensor sheet 13 and the duct sheet 14.

<Sub-Step S21 of Measuring Shrinkage>

Ceramic materials for the ceramic sheets 12 to 14 are prepared first.

At this sub-step, the alumina mixed powder M12 made at sub-step S13 is used as the ceramic material for the diffusion sheet 12. A zirconia powder with yttria solid solution, for example, is used as the ceramic material for the sensor sheet 13. Also, an alumina powder “c” having small mean particle diameter and high tap density is used as the ceramic material for the duct sheet 14.

Using the ceramic materials mentioned above, various ceramic sheets having different organic-volume rates are made for each of the ceramic sheets 12 to 14. Baking shrinkage of each of these ceramic sheets 12 to 14 is measured on the condition that baking is performed at a predetermined temperature in the baking step. The baking temperature in the present embodiment is 1,460 C.

As shown in FIG. 3, a relation is obtained between the organic-volume rate and the baking shrinkage for each of the ceramic sheets 12 to 14. FIG. 3 indicates approximate lines of measured values for the respective ceramic sheets.

<Sub-Step S22 of Selecting Organic-Volume Rate>

Subsequently, based on the relation between the organic-volume rate and the baking shrinkage (see FIG. 3) obtained for each of the ceramic sheets at sub-step S21, an organic-volume rate of each of the ceramic sheets 12 to 14 is selected so that the ceramic sheets 12 to 14 may all have substantially the same baking shrinkage as desired.

In the present embodiment, the diffusion sheet 12 having organic materials by a volume rate of 50%, which has been made using the alumina mixed powder M12, is used as a reference sheet, and the baking shrinkage of each of the sensor sheet 13 and the duct sheet 14 is adjusted to the reference sheet. The reason for using the diffusion sheet 12 as a reference sheet is that the after-baking porosity of the diffusion sheet 12 has previously been adjusted, and that the baking shrinkage of the sensor sheet 13 and the duct sheet 14 is adjusted to that of the diffusion sheet 12.

As can be seen from FIG. 3, the baking shrinkage of the reference diffusion sheet 12 is 18%. Accordingly, in the present embodiment, the organic-volume rate of the sensor sheet 13 is selected as being 38.5% and that of the duct sheet 14 is selected as being 39% so that the baking shrinkage of 18% may be ensured. As a matter of course, the organic-volume rate of the diffusion sheet 12 is 50%.

Then, a step S3 of FIG. 1 is performed to adjust baking-shrinkage profiles of the ceramic sheets 11 to 15. Step S3 includes a sub-step S31 of measuring profile for every time period of disintegration, a sub-step S32 of selecting disintegration time period and a sub-step S33 of making disintegrated ceramic material, and these sub-steps are performed in this order. Thus, subsequent to the adjustment of the after-baking porosity of the diffusion sheet 12, and the matching of the baking shrinkage of the ceramic sheets 11 to 15, the ceramic materials for the ceramic sheets are adjusted in advance, in consideration of matching the baking-shrinkage profiles.

It should be appreciated that, as at step S2 of adjusting baking shrinkage, step S3 of matching profiles is performed subjecting the diffusion sheet 12, the sensor sheet 13 and the duct sheet 14 (the shield and the heater sheets 11 and 15 are made of substantially the same ceramic material as the duct sheet 14). It should also be appreciated that the diffusion sheet 12 that has been made with the alumina mixed powder M12 and having organic materials by a volume rate of 50% is used as a reference sheet for matching the baking-shrinkage profiles of the sensor sheet 13 and the duct sheet 14.

<Sub-Step S31 of Measuring Profile for Every Time Period>

The ceramic materials for the sensor sheet 13 and the duct sheet 14 are prepared first.

At this sub-step, the ceramic material used for the sensor sheet 13 is a disintegrated zirconia powder (disintegrated ceramic powder) obtained by granulating zirconia powder using spray-drying technique, degreasing the granulated zirconia powder (granulated ceramic powder), followed by mixing a solvent, and disintegrating the resultant using a ball mill. The ceramic material used for the duct sheet 14 is a disintegrated alumina powder (disintegrated ceramic powder) obtained by granulating an alumina powder “c” using a spray-drying technique, degreasing the granulated alumina powder (granulated ceramic powder), followed by mixing a solvent, and disintegrating the resultant using a ball mill.

Subsequently, each of the granulated zirconia powder and the granulated alumina powder is disintegrated for various time periods. The various disintegrated zirconia and alumina powders obtained in this way using various disintegration time periods are formed into various sensor sheets 13 and duct sheets 14, respectively. In this case, the organic-volume rates of the sensor sheet 13 and the duct sheet 14 are ensured to be 38.5% and 39%, respectively, as selected at sub-step S22. Then, baking-shrinkage profiles are measured for the sensor sheets 13 and the duct sheets 14 on the condition that those sheets 13 and 14 are baked in the baking step.

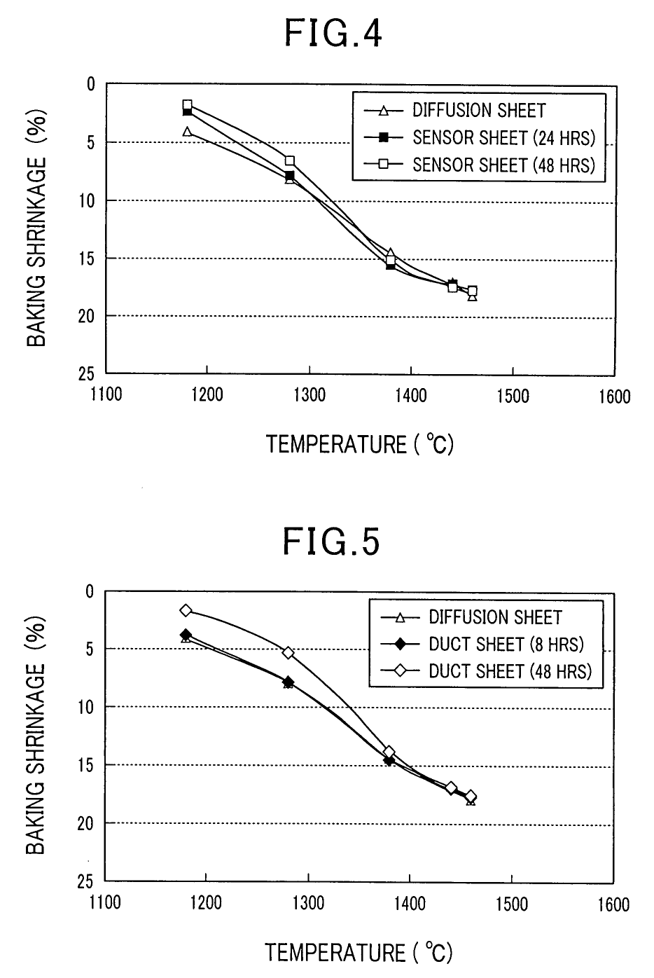

Thus, as shown in FIG. 4, a relation is obtained between the baking-shrinkage profiles and the disintegration time periods (24 and 48 hours) of the granulated zirconia powder, involved in the sensor sheets 13. Also, as shown in FIG. 5, a relation is obtained between the baking-shrinkage profiles and the disintegration time periods (8 and 48 hours) of the granulated alumina powder, involved in the duct sheets 14.

<Sub-Step S32 of Selecting Disintegration Time Period>

Then, based on the relations between the baking-shrinkage profiles and the disintegration time periods (see FIGS. 4 and 5) obtained at sub-step S31, the disintegration time periods of the respective granulated zirconia powder and granulated alumina powder are selected, so that the baking-shrinkage profiles of the sensor sheet 13 and the duct sheet 14, respectively, may approximate that of the reference diffusion sheet 12.

As can be seen from FIGS. 4 and 5, the time period selected for the granulated zirconia powder in the present embodiment is 24 hours and that for the granulated alumina powder is 8 hours.

<Sub-Step S33 of Making Disintegrated Ceramic Material>

Subsequently, based on the disintegration time period selected at sub-step S32, the granulated zirconia powder obtained by granulating the zirconia powder is disintegrated for 24 hours to make a disintegrated zirconia powder M13 (disintegrated ceramic material). Similarly, based on the disintegration time period selected at sub-step S32, the granulated alumina powder obtained by granulating the alumina powder “c” is disintegrated for 8 hours to make a disintegrated alumina powder M14 (disintegrated ceramic material).

At a later step, these disintegrated zirconia powder M13 and disintegrated alumina powder M14 are used as the ceramic materials for the sensor sheet 13 and the duct sheet 14, respectively.

The next step is a step S4 of fabricating a ceramic stack 1. Step S4 includes a sub-step S41 of forming sheets and a sub-step S42 of baking.

<Sub-Step S41 of Forming Sheets>

The ceramic sheets 11 to 15 (see FIG. 7) are fabricated first.

As will be appreciated from the above description, in fabricating the diffusion sheet 12, the alumina mixed powder M12 is prepared by mixing the alumina powders “a” and “b” at a ratio of 2:8, and then organic materials, such as a binder, a dispersant and a plasticizer, are mixed into the alumina mixed powder M12 so that the organic-volume rate may be 50% as have been selected in advance. This diffusion sheet material is then formed into the diffusion sheet 12 by using the doctor-blade technique.

As will be appreciated from the above description, in fabricating the sensor sheet 13, the disintegrated zirconia powder M13 is prepared by granulating the zirconia powder and disintegrating the granulated zirconia powder for 24 hours, and then organic materials, such as a binder, a dispersant and a plasticizer, are mixed into the disintegrated zirconia powder M13 so that the organic-volume rate may be 38.5% as have been selected in advance. This sensor sheet material is then formed into the sensor sheet 13 by using the doctor blade technique.

As will be appreciated from the above description, in fabricating the duct sheet 14, the disintegrated alumina powder M14 is prepared by granulating the alumina powder “c” and disintegrating the granulated alumina powder for 8 hours, and then organic materials, such as a binder, a dispersant and a plasticizer, are mixed into the disintegrated alumina powder M14 so that the organic-volume rate may be 39% as have been selected in advance. This duct sheet material is then formed into the duct sheet 14 by using the doctor blade technique.

The shield sheet 11 and the heater sheet 15 are fabricated in the same manner as the duct sheet 14 by using the same materials as the duct sheet 14.

A plural number of duct sheets 14 are stacked and the groove portion 141 is formed therein, as shown in FIG. 7, to provide the duct layer 14 that functions as the reference gas chamber 14. Also, the sensor sheet 13 is provided with the electrode 16 on the side of a gas to be measured, the electrode 17 on the side of a reference gas, lead portions 161 and 171, and the terminal portions 162, 172 and 173. Further, the through hole 130 is formed and filled with a conductor.

Further, the heater sheet 15 is provided with the heater element 19, the lead portion 191 and the terminal portion 192. Then, the through hole 150 is formed and filled with a conductor.

<Sub-Step S42 of Baking>

As shown in FIG. 7, the fabricated ceramic sheets 11 to 15 are stacked in the order of the shield sheet 11, the diffusion sheet 12, the sensor sheet 13, the duct sheet 14 and the heater sheet 15. These ceramic sheets are then bonded together such as by thermal compression. The stack obtained in this way is then baked at a maximum temperature of 1,460 C for integration.

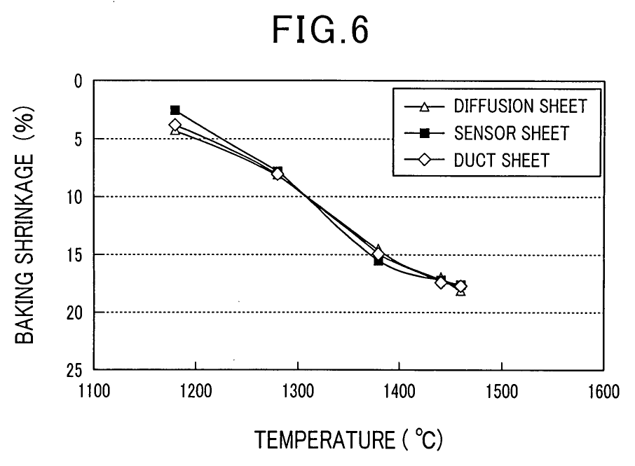

FIG. 6 shows the baking-shrinkage profiles of the diffusion sheet 12, the sensor sheet 13 and the duct sheet 14 (shield sheet 11 and the heater sheet 15). As can be seen from FIG. 6, the final baking shrinkages are 18.02% for the diffusion sheet 12, 17.65% for the sensor sheet 13, and 17.87% for the duct sheet 14. The difference between the maximum and the minimum values is 1% or less.

In this way, the gas sensing element (ceramic stack) 1 can be obtained, in which a plurality of ceramic layers are stacked in the order of the shield layer 11, the diffusion layer 12, the sensor layer 13, the duct layer 14 and the heater layer 15.

The advantageous effects of the method for manufacturing the ceramic stack 1 of the present embodiment are explained below.

In the manufacturing method according to the present embodiment, step S2 is performed to match the baking shrinkage of the ceramic sheets 11 to 15. Specifically, at sub-step S21 of measuring baking shrinkage, a relation between the organic-volume rates and the baking shrinkages after being baked is obtained for the ceramic sheets 11 to 15. More specifically, investigation is made as to how the baking shrinkage varies depending on the organic-volume rate of each of the ceramic sheets 11 to 15. Then, at sub-step S22, the organic-volume rate of each of the ceramic sheets 11 to 15 is selected based on the relation between the organic-volume rate and the baking shrinkage obtained at the previous sub-step, so that all of the ceramic sheets 11 to 15 may have substantially the same baking shrinkage as desired.

Thus, the ceramic sheets 11 to 15 obtained at sub-step S41 should have substantially been fabricated as having the same baking shrinkage. Accordingly, the plural types of ceramic sheets 11 to 15, when they are stacked and baked for integration at sub-step S42, may all exhibit substantially the same baking shrinkage. Thus, distortion, separation, cracking and the like of the ceramic sheets 11 to 15, which may result from baking, can be suppressed, and hence the ceramic stack 1 to be obtained may have high dimensional accuracy and high qualities.

In the present embodiment, the after-baking porosity of the diffusion sheet 12 is adjusted at step S1. Thus, a desired after-baking porosity can be determined for the diffusion sheet 12.

Further, the baking-shrinkage profile of each of the ceramic sheets 11 to 15 is adjusted at step S3. Accordingly, the baking-shrinkage profiles of all the ceramic sheets 11 to 15 can be more approximated. Thus, distortion, separation, cracking and the like of the ceramic sheets 11 to 15, which may result from baking, can be further suppressed, and hence the ceramic stack 1 to be obtained may have higher dimensional accuracy and higher qualities.

As described above, the granulated zirconia powder and the granulated alumina powder are made utilizing the spray-drying technique. Use of this spray-drying technique may facilitate the granulation of the zirconia powder and the alumina powder. Also, the spray-drying technique may enable adjustment of the degree of agglomeration of the zirconia powder and the alumina powder. As a result, more accurate adjustment may advantageously be ensured in the baking-shrinkage profiles of the ceramic sheets 11 to 15.

At sub-step S41, the sheet materials are formed into the ceramic sheets 11 to 15 using the doctor-blade technique. This may reduce such defect as voids in the after-baking ceramic sheets 11 to 15. Thus, the strength of the ceramic sheets 11 to 15 after baking can be enhanced, which may enhance the durability of the ceramic stack 1 to be obtained.

Advantageously, the difference between the maximum and minimum baking shrinkages is 1% or less in the plural types of ceramic sheets 11 to 15 baked for integration at sub-step S42. Thus, distortion, separation, cracking and the like of the ceramic sheets 11 to 15, which may result from baking, can be sufficiently suppressed, and hence the ceramic stack 1 to be obtained may have higher dimensional accuracy and higher qualities.

As mentioned above, the ceramic stack 1 can be applied to a gas sensing element. The excellent characteristics of the ceramic stack 1, i.e. dimensional accuracy and high qualities, may be prominently exerted in the application to such a gas sensing element. In particular, in light of the fact that the downsizing has increasingly advanced in gas sensors lately, and that the gas sensors have come to be used under higher-temperature circumstances, the gas sensors are now required to have higher dimensional accuracy and durability. The application of the high-quality ceramic stack 1 to a gas sensing element may realize downsizing of the gas sensor, and at the same time, may provide a gas sensor having excellent durability.

As described above, according to the method of manufacturing a ceramic stack of the present embodiment, distortion, separation, cracking and the like can be suppressed in stacking and baking for integration of the plural types of ceramic sheets.

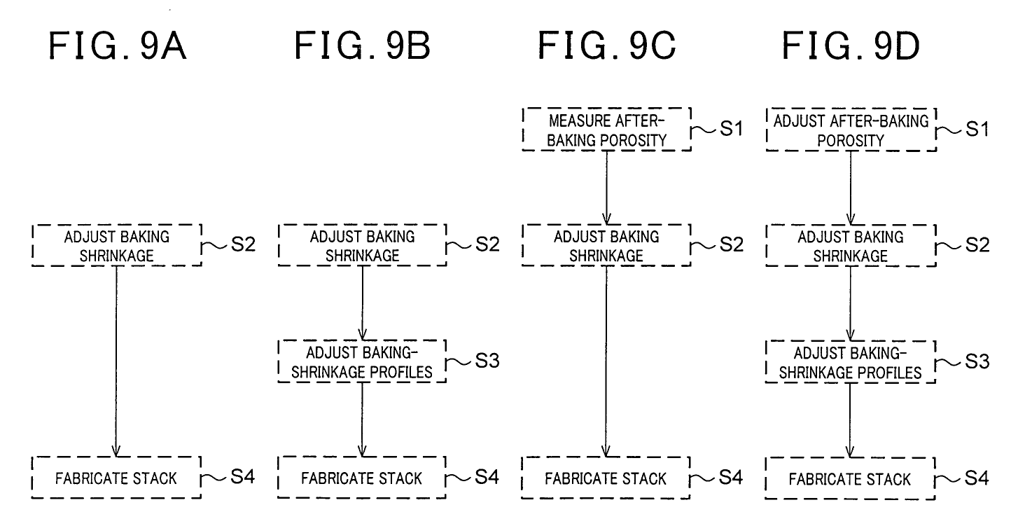

In the above description, the plural types of ceramic sheets of the present embodiment have included a ceramic sheet whose after-baking porosity is to be adjusted. Further, all of the ceramic sheets in the present embodiment have been matched as to the baking shrinkage and the baking-shrinkage profile by performing various steps, as shown in FIG. 9D, which are step S1 of adjusting porosity, step S2 of adjusting baking shrinkage, step S3 of adjusting profile and step 54 of fabricating a stack.

Alternatively, for example, where the plural types of ceramic sheets are to be matched as to the baking shrinkage alone, steps S2 and 54 alone may be performed as shown in FIG. 9A.

Also, as shown in FIG. 9B, where the plural types of ceramic sheets are to be matched as to the baking shrinkage and the baking-shrinkage profile, steps S2, S3 and $4 may be performed in this order.

Further, as shown in FIG. 9C, where the plural types of ceramic sheets include a ceramic sheet whose after-baking porosity is to be adjusted and where these plural types of ceramic sheets are to be matched as to the baking shrinkage, steps S1, S2 and S4 may be performed in this order.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A method of manufacturing an integrated ceramic stack containing a plurality of types of ceramic sheets, comprising:
an obtaining step in which a relationship between a rate of volume of an organic matter being contained in each of the ceramic sheets and a shrinkage of each of the ceramic sheets during a baking process thereof is obtained, the relationship being based on a case where each of the ceramic sheets is prepared as a sheet material in which a ceramic material is mixed with the organic matter of a predetermined amount, the sheet material is formed, and then formed sheet material is baked at a predetermined temperature;
a selecting step in which the rate of the volume of the organic matter being contained in each of the ceramic sheets is selected using the obtained relationship so that all the ceramic sheets have desired shrinkages falling into a predetermined range of shrinkages when the plurality of types of ceramic sheets are baked;
a sheet forming step in which each of the sheet materials is prepared by mixing the organic matter with the ceramic material based on the selected rate of the volume of the organic matter and the prepared sheet materials are formed into the plurality of types of ceramic sheets; and
a baking step in which the plurality of types of ceramic sheets are stacked on one another and the stacked ceramic sheets are baked to produce the integrated ceramic stack.

2. The method of claim 1, wherein the plurality of types of ceramic sheets includes a porosity adjusting sheet of which ceramic material is given as a ceramic adjusting material composed of a mixture of two types of adjustment materials for adjusting the porosity, the two types of adjustment materials being different in particle diameter and/or tap density from each other,
the method further comprising:
a further obtaining step in which a relationship between a mixture ratio of the two types of adjustment materials in the ceramic adjusting material and the porosity of the porosity adjusting sheet is obtained, the relationship between the mixture ratio and the porosity being based on a case where the porosity adjusting sheet in which the organic matter is mixed with the ceramic adjusting material at a selected volume rate is baked;
a further selecting step in which the mixture ratio of the adjustment materials is selected using the obtained relationship between the mixture ratio and the porosity so that the porosity adjusting sheet has a desired porosity after the baking; and
a producing step in which the two types of adjustment materials are mixed with each other based on the selected mixture ratio so as to produce the ceramic adjusting material, the producing step for producing the ceramic adjusting material being followed by the obtaining step for obtaining the relationship between the volume rate and the shrinkage,
wherein the selecting step for selecting the volume rate is configured to select the volume ratio of the organic matter being contained in each of the ceramic sheets using the obtained relationship between the volume ratio and the shrinkage so that all the ceramic sheets have shrinkages falling into a predetermined range into which the shrinkage of the porosity adjusting sheet falls, when the plurality of types of ceramic sheets are baked.

3. The method of claim 1, wherein the plurality of types of ceramic sheets includes a profile adjusting sheet for adjusting a profile indicating behaviors of the shrinkage when being baked and being expressed by a relationship between a baking temperature and the shrinkage, the profile adjusting sheet using a disintegrated ceramic material produced by disintegrating granulated ceramic powders for a predetermined period of time, the granulated ceramic powders being formed by granulating the ceramic material,
the method further comprising:
a further obtaining step, which follows the selecting step for selecting the volume rate of the organic matter, in which, when the profile adjusting sheet is backed, the profile is obtained every disintegration time during which the granulated ceramic powers are subjected to the disintegration;
a further selecting step in which, based on a relationship between the obtained profile and the disintegration time, a disintegration time for the granulated ceramic powders is selected such that the profile of the profile adjusting sheet best approaches a profile of the shrinkage of a ceramic sheet selected other than the profile adjusting sheet; and
a producing step in which, based on the selected disintegration time, the granulated ceramic powders are disintegrated to produce the disintegrated ceramic material,
wherein the sheet forming step, which follows the producing step for producing disintegrated ceramic material, is configured to form the ceramic sheets such that the profile adjusting sheet uses, as the ceramic material therefor, the disinterested ceramic material produced in the producing step for producing the disintegrated ceramic material.

4. The method of claim 2, wherein the plurality of types of ceramic sheets includes a profile adjusting sheet for adjusting a profile indicating behaviors of the shrinkage when being baked and being expressed by a relationship between a baking temperature and the shrinkage, the profile adjusting sheet using a disintegrated ceramic material produced by disintegrating granulated ceramic powders for a predetermined period of time, the granulated ceramic powders being formed by granulating the ceramic material,
the method further comprising:
a further obtaining step, which follows the selecting step for selecting the volume rate of the organic matter, in which, when the profile adjusting sheet is backed, the profile is obtained every disintegration time during which the granulated ceramic powers are subjected to the disintegration;
a further selecting step in which, based on a relationship between the obtained profile and the disintegration time, a disintegration time for the granulated ceramic powders is selected such that the profile of the profile adjusting sheet best approaches a profile of the shrinkage of the porosity adjusting sheet; and
a producing step in which, based on the selected disintegration time, the granulated ceramic powders are disintegrated to produce the disintegrated ceramic material,
wherein the sheet forming step, which follows the producing step for producing disintegrated ceramic material, is configured to form the ceramic sheets such that the profile adjusting sheet uses, as the ceramic material therefor, the disinterested ceramic material produced in the producing step for producing the disintegrated ceramic material.

5. The method of claim 4, wherein the granulated ceramic powders are produced by granulating the ceramic material based on a spray-drying technique.

6. The method of claim 1, wherein the sheet forming step is configured to produce the ceramic sheets by forming the seat materials based on a doctor-blade technique.

7. The method of claim 1, wherein the shrinkages of the plurality of type of ceramic sheets subjected to the baking step have a maximum shrinkage and a minimum shrinkage, a difference between the maximum and minimum shrinkages being within 1%.

8. The method of claim 1, wherein the ceramic stack is used as an element for sensing a gas.

9. The method of claim 2, wherein the sheet forming step is configured to produce the ceramic sheets by forming the seat materials based on a doctor-blade technique.

10. The method of claim 2, wherein the shrinkages of the plurality of type of ceramic sheets subjected to the baking step have a maximum shrinkage and a minimum shrinkage, a difference between the maximum and minimum shrinkages being within 1%.

11. The method of claim 2, wherein the ceramic stack is used as an element for sensing a gas.

12. The method of claim 3, wherein the granulated ceramic powders are produced by granulating the ceramic material based on a spray-drying technique.

13. The method of claim 3, wherein the sheet forming step is configured to produce the ceramic sheets by forming the seat materials based on a doctor-blade technique.

14. The method of claim 3, wherein the shrinkages of the plurality of type of ceramic sheets subjected to the baking step have a maximum shrinkage and a minimum shrinkage, a difference between the maximum and minimum shrinkages being within 1%.

15. The method of claim 3, wherein the ceramic stack is used as an element for sensing a gas.

16. The method of claim 4, wherein the sheet forming step is configured to produce the ceramic sheets by forming the seat materials based on a doctor-blade technique.

17. The method of claim 4, wherein the shrinkages of the plurality of type of ceramic sheets subjected to the baking step have a maximum shrinkage and a minimum shrinkage, a difference between the maximum and minimum shrinkages being within 1%.

18. The method of claim 4, wherein the ceramic stack is used as an element for sensing a gas.

19. A method of manufacturing an integrated ceramic stack containing a plurality of types of ceramic sheets, comprising steps of:
obtaining a relationship between a rate of volume of an organic matter being contained in each of the ceramic sheets and a shrinkage of each of the ceramic sheets during a baking process thereof, the relationship being based on a case where each of the ceramic sheets is prepared as a sheet material in which a ceramic material is mixed with the organic matter of a predetermined amount, the sheet material is formed, and then formed sheet material is baked at a predetermined temperature;
selecting the rate of the volume of the organic matter being contained in each of the ceramic sheets using the obtained relationship so that all the ceramic sheets have desired shrinkages falling into a predetermined range of shrinkages when the plurality of types of ceramic sheets are baked;
producing each of the sheet materials by mixing the organic matter with the ceramic material based on the selected rate of the volume of the organic matter;
forming the prepared sheet materials into the plurality of types of ceramic sheets; and
baking the plurality of types of ceramic sheets stacked on one another to produce the integrated ceramic stack.
